(19) United States
(12) Patent Application Publication
(10) Pub. No.: US 2010/0278507 A1
(43) Pub. Date: Nov. 4, 2010

(54) Subtitle Generation System and Method Thereof

(75) Inventor: Hong-Wei Zhou, Chengdu (CN)

Correspondence Address: WPAT, PC;INTELLECTUAL PROPERTY ATTORNEYS, 2030 MAIN STREET, SUITE 1300, IRVINE, CA, 92614, US

(73) Assignee: Mitac International Corp., Taoyuan (TW)

(21) Appl. No.: 12/545,485

(22) Filed: Aug. 21, 2009

(30) Foreign Application Priority Data
Apr. 30, 2009 (TW) 098114530

(51) Int. Cl. H04N 7/00

(52) U.S. Cl. 386/95; 386/E05.001

(57) ABSTRACT

The present invention discloses a subtitle generation system and method thereof. The subtitle generation method according to the present invention comprising the following steps: initially, creating a transparent base map; next, determining a original data format of subtitles; if the original data format of the subtitles is a bitmap, then by way of direct memory access, drawing the bitmap onto the transparent base map in order to render the subtitles.

### BACKGROUND OF THE INVENTION

1. Field of the Invention

The present invention relates to a multimedia playback technology; in particular, the present invention relates to a subtitle generation system and method thereof.

2. Description of Related Art

In order to support subtitle presentation in many different languages, most of conventional multimedia audio/video playback technologies use real-time graphic computation to show subtitles on display screens.

In 1997, European Telecommunications Standards Institute (ETSI) officially released Digital Video Broadcasting for Terrestrial (DVB-T) as technical standards for European terrestrial digital video broadcast transmissions, and most countries have adopted digital television terrestrial broadcast systems for deploying their terrestrial digital video broadcast networks. In the standards of digital television terrestrial broadcast concerning subtitles, original data for subtitles can be specified in the bitmap with Run-Length Coding (RLC) or in the character data format. The outputs of subtitles are mostly processed through such as a Graphics Device Interface (GDI), Open Graphics Library (OpenGL), DirectDraw software system or Direct3D application programming interface (API).

Nowadays, because modern personal computers (PC) are commonly installed with one or more powerful central process units (CPU), independent graphic process unit (GPU) and memories of massive capacity, the performance of the subtitle output on PC in the aforementioned approaches is essentially satisfactory.

However, with regards to handheld devices, e.g. smart phone, Personal Digital Assistant (PDA), portable multimedia player (PMP), due to feeble computation ability and the lack of hardware acceleration feature, in most cases, real-time generation of subtitles is difficult to be achieved by using any of the above-said solutions.

### SUMMARY OF THE INVENTION

In view of the drawbacks stated in previous texts, one objective of the present invention is to provide a subtitle generation system and method thereof, thereby solving the problems of real-time subtitle output on devices having limited hardware performance.

According to another objective of the present invention, herein a subtitle generation method is proposed, comprising the following steps: initially, creating a transparent base map; next, determining a original data format of subtitles; if the original data format of the subtitles is a bitmap, then by means of direct memory access, drawing the bitmap onto the transparent base map in order to render the subtitles.

Herein the bitmap can be encoded by means of a Run-Length Coding (RLC) method.

Herein, if the original data format of the subtitles is character data, then the character data can be drawn onto the transparent base map by using Graphics Device Interface (GDI), Open Graphics Library (OpenGL), a DirectDraw software system or Direct3D application programming interface and so forth, thereby generating the subtitles.

According to yet another objective of the present invention, herein a subtitle generation system is proposed, comprising: a base map generation module, a determination module and a subtitle generation module. The base map generation module can be used to create the transparent base map. The determination module determines the original data format of the subtitles, and generates the determination result. In case the determination result indicates it is bitmap, then the subtitle generation module, by means of direct memory access, draws the bitmap onto the transparent base map to render the subtitles.

Herein, the bitmap can be encoded by means of a Run-Length Coding (RLC) method.

Herein, if the original data format of the subtitles is character data, then the subtitle generation module can draw the character data onto the transparent base map by using Graphics Device Interface (GDI), Open Graphics Library (OpenGL), a DirectDraw software system or Direct3D API and the like, thereby generating the subtitle.

In summary, the subtitle generation system and method thereof provides one or more following advantages:

(1) computations of subtitle generation can be effectively reduced through the direct memory access, thereby enabling fast subtitle generation;

(2) applicable for devices having feeble computation ability and the lack of hardware acceleration feature, allowing to meet the requirement on real-time subtitle generation.

### BRIEF DESCRIPTION OF THE DRAWINGS

FIG. 1 is a flowchart for the subtitle generation method according to the present invention;

FIG. 2 is a diagram for the subtitle generation system according to the present invention; and

FIGS. 3A to 3D are diagrams for an embodiment of the subtitle generation system and method thereof according to the present invention.

### DETAILED DESCRIPTION OF THE PREFERRED EMBODIMENTS

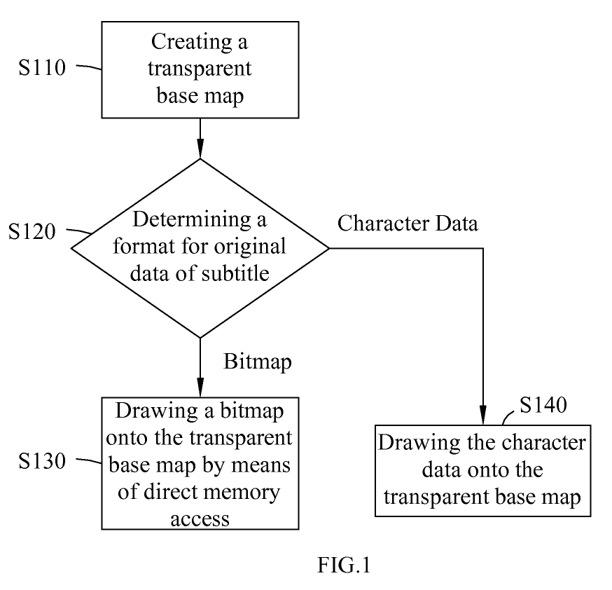

Refer first to FIG. 1, wherein a flowchart for the subtitle generation method according to the present invention is shown. The subtitle generation method as the Figure comprises the following steps: in STEP S110, a transparent base map is created; in STEP S120, a original data format of subtitles is determined. If the original data format of the subtitles is bitmap, then as shown in STEP S130, the bitmap is drawn onto the transparent base map by means of direct memory access in order to render the subtitles. Otherwise, if the original data format of the subtitles is character data, STEP S140 is performed for drawing the character data onto the transparent base map to render the subtitles.

Herein, in STEP S140, the subtitles can be drawn by using Graphics Device Interface (GDI), Open Graphics Library (OpenGL), a DirectDraw software system or Direct3D API and the like.

The method according to the present invention is applicable for a multimedia playback system, and can be used in electronic devices employing Digital Video Broadcasting for Terrestrial (DVB-T) as well.

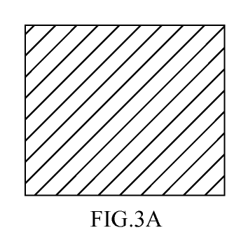

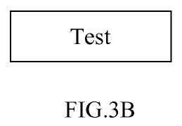

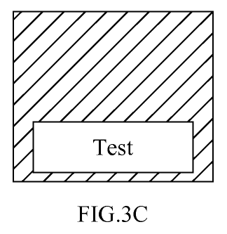

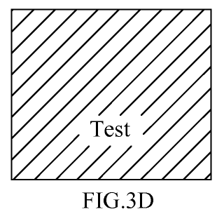

Subsequently, refer to FIGS. 3A to 3D, wherein a diagram for an embodiment of the subtitle generation system and method thereof according to the present invention are shown. Hereunder the present disclosure takes FIGS. 3A to 3D as an example, also conjunctively referring to FIG. 1, for illustrating the process of the subtitle generation method according to the present invention.

At the beginning, the method creates a transparent base map, as indicated in FIG. 3A. Next, it determines the original data format of the subtitles. Since the original data format of the subtitles is a bitmap, as illustrated in FIG. 3B, it draws the bitmap file in FIG. 3B onto the transparent base map in FIG. 3A by way of direct memory access. The result thereof can be referred to FIG. 3C.

Whereas, in case the original data format of the subtitles is character data, e.g. “Test”, then the method directly draws such character data onto the transparent base map in FIG. 3A by way of a Graphics Device Interface (GDI), Open Graphics Library (OpenGL), DirectDraw software system or Direct3D application programming interface (API) etc. The result thereof can be referred to FIG. 3D.

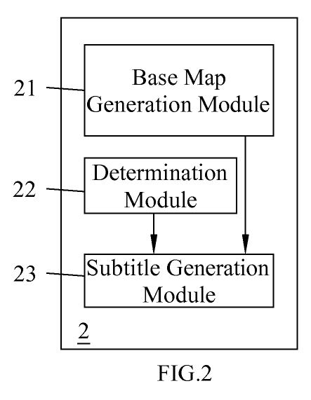

Refer now to FIG. 2, wherein a diagram for the subtitle generation system according to the present invention is shown. In the Figure, the subtitle generation system 2 comprises a base map generation module 21, a determination module 22 and a subtitle generation module 23. The base map generation module 21 can be used to create the transparent base map. The determination module 22 determines the original data format of the subtitles, and generates the determination result. If the determination result indicates it is a bitmap, then the subtitle generation module 23, by way of direct memory access, draws the bitmap onto the transparent base map to generate the subtitle.

Herein if the original data format of the subtitles is character data, then the subtitle generation module 23 can draw the character data onto the transparent base map by using Graphics Device Interface (GDI), Open Graphics Library (OpenGL), a DirectDraw software system or Direct3D API etc., thereby generating the subtitles.

The system according to the present invention is applicable for a multimedia playback system, and can also be used in electronic devices employing Digital Video Broadcasting for Terrestrial (DVB-T).

Following this, refer next to FIGS. 3A to 3D, wherein diagrams for an embodiment of the subtitle generation system and method thereof according to the present invention are shown. Hereunder the present disclosure takes FIGS. 3A to 3D as an example, also conjunctively referring to FIG. 2, for illustrating the operation of the subtitle generation system according to the present invention.

Initially, the base map generation module 21 creates a transparent base map, as indicated in FIG. 3A. Next, the determination module 22 determines the original data format of the subtitles and generates a determination result. Subsequently, since the original data format of the subtitles is a bitmap, as illustrated in FIG. 3B, the subtitle generation module 23 draws the bitmap file in FIG. 3B onto the transparent base map in FIG. 3A by way of direct memory access. The result thereof can be referred to FIG. 3C.

Whereas, in case the original data format of the subtitles is character data, e.g. “Test”, then the subtitle generation module 23 directly draws such a character data onto the transparent base map in FIG. 3A by using Graphics Device Interface (GDI), Open Graphics Library (OpenGL), a DirectDraw software system or Direct3D application programming interface (API), etc. The result thereof can be referred to FIG. 3D.

In the subtitle generation system and method thereof as well as embodiments thereof, for the relevant data employed therein, the bitmap can be encoded by a Run-Length Coding (RLC) method. The character data can be expressed through character encoding; for example, BIG5, Unicode, HKSCS, ISO/IEC 646, ISO/IEC 8859, EBCDIC, GB 18030, GB 2312 and so forth.

To further explain the feature of performance improvement provided by the subtitle generation system and method thereof according to the present invention, hereunder a performance comparison of subtitle generation is made under the same conditions between using Graphics Device Interface (GDI), a DirectDraw software system and the approach of direct memory access according to the present invention. The test algorithm is, through the abovementioned three methods, to respectively generate 10 times the subtitles with the same subtitle bitmap, and to record one by one the start time and end time of each subtitle generation (by means of the system function GetTickCount( ) for time marking, and the time unit used herein is millisecond (ms)), whose comparison results are shown hereunder in Table 1.

As indicated in Table 1, by using the direct memory access for subtitle generation, the process can be accomplished within 30 ms. But, in case the subtitle generation is executed based on GDI or DirectDraw, it may require more than 900 ms to have the process done.

TABLE 1
Table for Performance Comparison of Subtitle Generation

| | Graphics Device | | | DirectDraw | | | | | |
|---|---|---|---|---|---|---|---|---|---|
| | Interface | | | (without H/W | | | Direct Memory | | |
| Method | (GDI) | | | acceleration) | | | Access (DMA) | | |
| No. | Start | End | Time | Start | End | Time | Start | End | Time |
| 1 | 1581825 | 1582768 | 943 | 193031 | 193968 | 937 | 1962018 | 1962045 | 27 |
| 2 | 1599282 | 1600233 | 951 | 270771 | 271696 | 925 | 2002421 | 2002448 | 27 |
| 3 | 1690843 | 1691792 | 949 | 879645 | 880555 | 910 | 2020431 | 2020460 | 29 |
| 4 | 1702628 | 1703586 | 958 | 896025 | 896944 | 919 | 2034348 | 2034376 | 28 |
| 5 | 1714240 | 1715187 | 947 | 910121 | 911030 | 909 | 2047326 | 2047355 | 29 |
| 6 | 1724374 | 1725301 | 927 | 921619 | 922540 | 921 | 2081513 | 2081540 | 27 |
| 7 | 1740888 | 1741847 | 959 | 935497 | 936425 | 928 | 2096338 | 2096366 | 28 |
| 8 | 1752727 | 1753651 | 924 | 948222 | 949144 | 922 | 2117421 | 2117449 | 28 |
| 9 | 1766604 | 1767541 | 937 | 970396 | 971363 | 967 | 2131246 | 2131273 | 27 |
| 10 | 1777351 | 1778293 | 942 | 985415 | 986362 | 947 | 2147835 | 2147863 | 28 |
| Average | | | 944 | | | 928.5 | | | 27.8 |

In summary, the subtitle generation system and method thereof according to the present invention provide the aspect of low computations, which is applicable for devices having feeble computation ability and the lack of hardware acceleration feature, e.g. smart phone, Personal Digital Assistant (PDA), portable multimedia play (PMP) and the like, thereby allowing to meet the requirement on real-time subtitle generation.

The aforementioned descriptions are exemplary, rather than being restrictive. All effectively equivalent changes or modifications made thereto without departing from the spirit and scope of the present invention are considered to be included by the claims set forth hereinafter.

What is claimed is:

1. A subtitle generation method comprising the following steps:
creating a transparent base map;
determining an original data format of subtitles; and
drawing the bitmap onto the transparent base map in order to render the subtitles by way of direct memory access if the original data format of the subtitles is a bitmap.

2. The subtitle generation method according to claim 1, wherein the bitmap is encoded by means of a Run-Length Coding (RLC) method.

3. The subtitle generation method according to claim 1, wherein the transparent base map is created by using Graphics Device Interface (GDI).

4. The subtitle generation method according to claim 1, wherein the method is applicable for electronic devices employing Digital Video Broadcasting for Terrestrial (DVB-T).

5. The subtitle generation method according to claim 1, wherein, in the step of determining the original data format of the subtitles, if the original data format of the subtitles is character data, then the character data is drawn onto the transparent base map to render the subtitle.

6. The subtitle generation method according to claim 5, wherein Graphics Device Interface (GDI) is used to draw the character data onto the transparent base map.

7. The subtitle generation method according to claim 5, wherein Open Graphics Library (OpenGL) is used to draw the character data onto the transparent base map.

8. The subtitle generation method according to claim 5, wherein a DirectDraw software system is used to draw the character data onto the transparent base map.

9. The subtitle generation method according to claim 5, wherein Direct3D application programming interface is used to draw the character data onto the transparent base map.

10. The subtitle generation method according to claim 5, wherein the character data is expressed by character encoding.

11. A subtitle generation system comprising:
a base map generation module used for creating a transparent base map;
a determination module determining an original data format of subtitles, and generating a determination result; and
a subtitle generation module, while the original data format of the subtitles is indicated by the determination result as a bitmap, drawing the bitmap onto the transparent base map by way of direct memory access to render the subtitles.

12. The subtitle generation system according to claims 11, wherein the bitmap is encoded by means of a Run-Length Coding (RLC) method.

13. The subtitle generation system according to claim 11, wherein the base map generation module creates the transparent base map by means of Graphics Device Interface (GDI).

14. The subtitle generation system according to claim 11, wherein the system is applicable for electronic devices employing Digital Video Broadcasting for Terrestrial (DVB-T).

15. The subtitle generation system according to claim 11, wherein, if the original data format of the subtitles is character data, then the subtitle generation module draws the character data onto the transparent base map to render the subtitles.

16. The subtitle generation system according to claim 15, wherein the subtitle generation module uses Graphics Device Interface (GDI) to draw the character data onto the transparent base map.

17. The subtitle generation system according to claim 15, wherein the subtitle generation module uses Open Graphics Library (OpenGL) to draw the character data onto the transparent base map.

18. The subtitle generation system according to claim 15, wherein the subtitle generation module uses a DirectDraw software system to draw the character data onto the transparent base map.

19. The subtitle generation system according to claim 15, wherein the subtitle generation module uses Direct3D application programming interface to draw the character data onto the transparent base map.

20. The subtitle generation system according to claim 15, wherein the character data is expressed by character encoding.
